(19) United States
(12) Patent Application Publication
(10) Pub. No.: US 2026/0299472 A1
(43) Pub. Date: Oct. 1, 2026

(54) HEATER, FIXING DEVICE, AND IMAGE FORMING APPARATUS

(71) Applicant: Yuusuke FURUICHI, Kanagawa (JP)

(72) Inventor: Yuusuke FURUICHI, Kanagawa (JP)

(21) Appl. No.: 19/557,199

(22) Filed: Mar. 5, 2026

(30) Foreign Application Priority Data
Mar. 26, 2025 (JP) 2025-052379

(51) Int. Cl. G03G 15/20

(52) U.S. Cl. CPC G03G 15/2053; G03G 15/2039; G03G 15/2064

(57) ABSTRACT

A heater heats a heated medium. The heater includes a center resistive heating element and a first conductor that is connected to one lateral end of the center resistive heating element in a longitudinal direction of the center resistive heating element. A second conductor is connected to another lateral end of the center resistive heating element in the longitudinal direction of the center resistive heating element. A first electrode is disposed opposite the center resistive heating element via the first conductor in the longitudinal direction of the center resistive heating element. The first electrode is connected to the first conductor. A second electrode is disposed opposite the center resistive heating element via the second conductor in the longitudinal direction of the center resistive heating element. The second electrode is connected to the second conductor.

### CROSS-REFERENCE TO RELATED APPLICATION

This patent application is based on and claims priority pursuant to 35 U.S.C. § 119(a) to Japanese Patent Application No. 2025-052379, filed on Mar. 26, 2025, in the Japan Patent Office, the entire disclosure of which is hereby incorporated by reference herein.

### BACKGROUND

### Technical Field

The present disclosure relates to a heater, a fixing device, and an image forming apparatus, and more particularly, to a heater, a fixing device incorporating the heater, and an image forming apparatus incorporating the fixing device.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a fixing device including a heater that heats a medium such as a sheet bearing a toner image. The heater includes a resistive heating element that is elongated and extended in a width direction of a medium having a maximum size available in the image forming apparatus.

### SUMMARY

The present disclosure described herein provides a heater that heats a heated medium. The heater includes a center resistive heating element and a first conductor that is connected to one lateral end of the center resistive heating element in a longitudinal direction of the center resistive heating element. A second conductor is connected to another lateral end of the center resistive heating element in the longitudinal direction of the center resistive heating element. A first electrode is disposed opposite the center resistive heating element via the first conductor in the longitudinal direction of the center resistive heating element. The first electrode is connected to the first conductor. A second electrode is disposed opposite the center resistive heating element via the second conductor in the longitudinal direction of the center resistive heating element. The second electrode is connected to the second conductor.

The present disclosure described herein further provides a heater that includes a first center resistive heating element and a second center resistive heating element that is arranged with the first center resistive heating element in a short direction of the first center resistive heating element. A first conductor is connected to the first center resistive heating element. A second conductor is connected to the second center resistive heating element. A third conductor connects the first center resistive heating element with the second center resistive heating element. A first electrode is disposed opposite the first center resistive heating element via the first conductor in a longitudinal direction of the first center resistive heating element. The first electrode is connected to the first conductor. A second electrode is disposed opposite the second center resistive heating element via the second conductor in a longitudinal direction of the second center resistive heating element. The second electrode is connected to the second conductor.

The present disclosure described herein further provides a fixing device that includes an endless belt that rotates and the heater described above that heats the endless belt.

The present disclosure described herein further provides an image forming apparatus that includes the fixing device described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming apparatus according to an embodiment of the present disclosure;

FIG. 2 is a schematic cross-sectional view of a fixing device incorporated in the image forming apparatus depicted in FIG. 1;

FIG. 3 is a plan view of a heater according to a first embodiment of the present disclosure, that is incorporated in the fixing device depicted in FIG. 2;

FIG. 4 is a plan view of the heater according to the first embodiment of the present disclosure depicted in FIG. 3;

FIG. 5 is a plan view of a heater according to a second embodiment of the present disclosure, that is installable in the fixing device depicted in FIG. 2;

FIG. 6 is a plan view of a heater according to a third embodiment of the present disclosure, that is installable in the fixing device depicted in FIG. 2;

FIG. 7 is a plan view of a heater according to a fourth embodiment of the present disclosure, that is installable in the fixing device depicted in FIG. 2;

FIG. 8 is a plan view of a heater according to a fifth embodiment of the present disclosure, that is installable in the fixing device depicted in FIG. 2;

FIG. 9 is a plan view of a heater according to a sixth embodiment of the present disclosure, that is installable in the fixing device depicted in FIG. 2;

FIG. 10 is a plan view of a heater according to a seventh embodiment of the present disclosure, that is installable in the fixing device depicted in FIG. 2;

FIG. 11 is a plan view of a heater according to an eighth embodiment of the present disclosure, that is installable in the fixing device depicted in FIG. 2;

FIG. 12 is a plan view of a heater according to a ninth embodiment of the present disclosure, that is installable in the fixing device depicted in FIG. 2;

FIG. 13 is a schematic diagram of the heater depicted in FIG. 12 and temperature detectors that are installed in the fixing device depicted in FIG. 2 as a first installation example of the temperature detectors;

FIG. 14 is a schematic diagram of the heater depicted in FIG. 12 and the temperature detectors that are installed in the fixing device depicted in FIG. 2 as a second installation example of the temperature detectors;

FIG. 15 is a schematic diagram of the heater depicted in FIG. 12 and the temperature detectors that are installed in the fixing device depicted in FIG. 2 as a third installation example of the temperature detectors;

FIG. 16 is a schematic diagram of the heater depicted in FIG. 12 and a thermal conductor that is installed in the fixing device depicted in FIG. 2 as a first installation example of the thermal conductor;

FIG. 17 is a schematic diagram of the heater depicted in FIG. 12 and a thermal conductor that is installable in the fixing device depicted in FIG. 2 as a second installation example of the thermal conductor; and

FIG. 18 is a schematic diagram of the heater depicted in FIG. 12 and a thermal conductor that is installable in the fixing device depicted in FIG. 2 as a third installation example of the thermal conductor.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to drawings, a description is provided of embodiments of the present disclosure. In the drawings for explaining the embodiments of the present disclosure, identical reference numerals are assigned to elements such as members and parts that have an identical function or an identical shape and a description of the elements is omitted once the description is provided.

A description is provided of a construction of an image forming apparatus 1000.

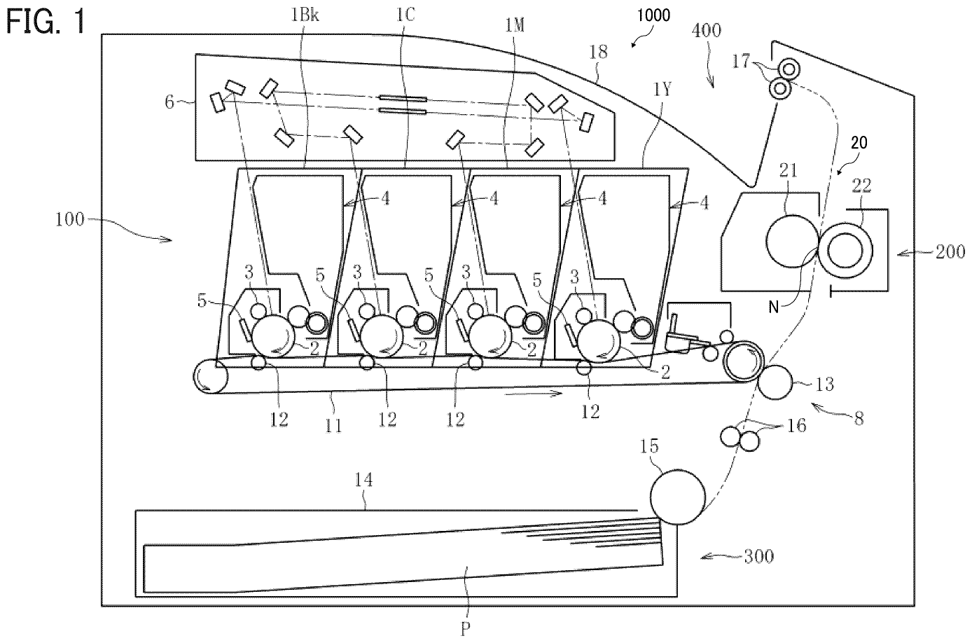

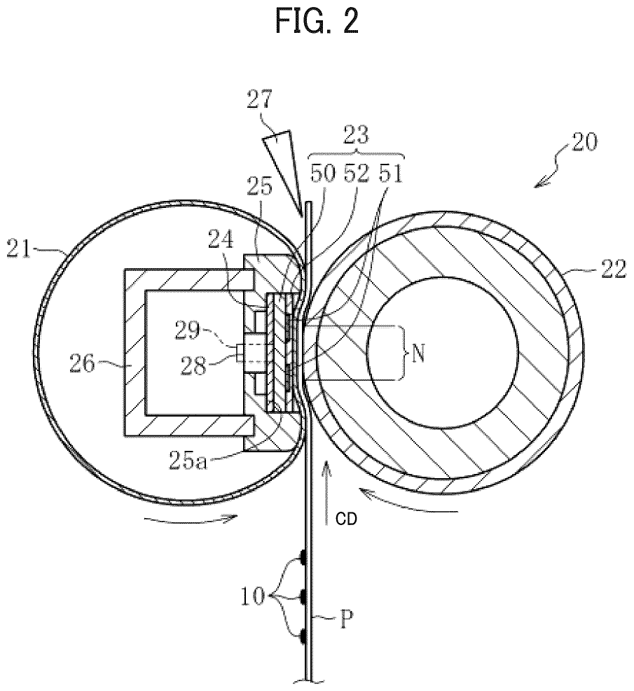

FIG. 1 is a schematic cross-sectional view of the image forming apparatus 1000 according to an embodiment of the present disclosure. An image forming apparatus disclosed in the present disclosure is a printer, a copier, a facsimile machine, a printing machine, a multifunction peripheral (MFP) having at least two of printing, copying, facsimile, scanning, and plotter functions, or the like. Image formation described below denotes forming an image having meaning such as characters and figures and an image not having meaning such as patterns. The following describes the construction of the image forming apparatus 1000 that forms a toner image on a recording medium by an electrophotographic method. However, the image forming apparatus may employ an image forming method other than the electrophotographic method. For example, the image forming apparatus may employ other image forming methods such as an inkjet method. In a case that the image forming apparatus employs the inkjet method, a heater 23 according to an embodiment of the present disclosure depicted in FIG. 2 may be applied to a dryer that dries an ink image formed on a heated medium.

The image forming apparatus 1000 includes an image forming portion 100, a fixing portion 200, a sheet supply portion 300, and a sheet output portion 400. The image forming portion 100 includes image forming units 1Y, 1M, 1C, and 1Bk, an exposure device 6, and a transfer device 8. The image forming units 1Y, 1M, 1C, and 1Bk serve as image forming devices that are removably installed in the image forming apparatus 1000. The image forming units 1Y, 1M, 1C, and 1Bk basically have similar constructions, respectively. However, the image forming units 1Y, 1M, 1C, and 1Bk contain developers (e.g., toners) in different colors, that is, yellow, magenta, cyan, and black, respectively. For example, each of the image forming units 1Y, 1M, 1C, and 1Bk includes a photoconductor 2, a charger 3, a developing device 4, and a cleaner 5. The photoconductor 2 is one example of a latent image bearer and an image bearer that bear a latent image and a toner image, respectively, on a surface (e.g., an outer circumferential face) of the photoconductor 2. The photoconductor 2 may be a drum depicted in FIG. 1 or an endless belt.

The charger 3 is a conductive member or a semiconductive member that applies a voltage onto the surface of the photoconductor 2, thus uniformly charging the surface of the photoconductor 2. For example, the charger 3 is a charging roller depicted in FIG. 1. Alternatively, the charger 3 may be a contact type charger such as a magnetic brush, a fur brush, film, and a rubber blade or a non-contact type charger using corona discharge. The developing device 4 supplies the developer onto the photoconductor 2. The developing devices 4 of the image forming units 1Y, 1M, 1C, and 1Bk contain developers (e.g., toners) in different colors, that is, yellow, magenta, cyan, and black, respectively, and supply the developers in the different colors onto the photoconductors 2, respectively. The cleaner 5 contacts the surface of the photoconductor 2 and removes residual toner and other foreign substance that remain on the surface of the photoconductor 2 therefrom. The cleaner 5 depicted in FIG. 1 is a cleaning blade. Alternatively, the cleaner 5 may be a brush roller that contacts the surface of the photoconductor 2 and rotates. The exposure device 6 is one example of a latent image forming device that forms a latent image on the surface of each of the photoconductors 2. The exposure device 6 employs an optical system such as a duplication optical system, a rod lens array system, a laser optical system, a liquid crystal shutter optical system, and a light-emitting diode (LED) optical system.

The transfer device 8 transfers yellow, magenta, cyan, and black toner images formed on the photoconductors 2, respectively, onto a sheet P serving as a heated medium. According to the embodiment, a sheet (e.g., a sheet P) is a sheet of paper. Alternatively, the sheet is not limited to paper. For example, as long as the image forming apparatus forms images using various image forming methods, a type and the like of the sheet are not limited to paper. The transfer device 8 includes an intermediate transfer belt 11, primary transfer rollers 12, and a secondary transfer roller 13. The intermediate transfer belt 11 is an endless belt that is stretched across and supported by a plurality of rollers including the primary transfer rollers 12. As at least one of the rollers supporting the intermediate transfer belt 11 serves as a driving roller, the driving roller drives and rotates the intermediate transfer belt 11 in a rotation direction indicated by arrow in FIG. 1. The intermediate transfer belt 11 is a belt having a single-layer structure or a multilayer structure. In a case that the intermediate transfer belt 11 has the multilayer structure, the intermediate transfer belt 11 includes a base layer and a coating layer. The base layer is made of stretch resistant fluororesin, polyvinylidene fluoride (PVDF), or polyimide resin. The coating layer coats the base layer. The coating layer is preferably made of a material having an enhanced smoothness such as fluororesin. In a case that the intermediate transfer belt 11 has the single-layer structure, the intermediate transfer belt 11 is preferably a belt that is made of PVDF, polycarbonate (PC), polyimide, or the like.

The four primary transfer rollers 12 are disposed within a loop formed by the intermediate transfer belt 11. The primary transfer rollers 12 are disposed opposite the photoconductors 2, respectively, via the intermediate transfer belt 11. The primary transfer rollers 12 contact an inner circumferential face of the intermediate transfer belt 11 at positions where the primary transfer rollers 12 are disposed opposite the photoconductors 2, respectively, via the intermediate transfer belt 11, thus forming primary transfer nips between the intermediate transfer belt 11 and the photoconductors 2. Alternatively, each of the primary transfer rollers 12 may be shifted downstream from a contact position (e.g., the primary transfer nip) where the photoconductor 2 contacts the intermediate transfer belt 11 for a predetermined distance in the rotation direction in which a surface of the intermediate transfer belt 11 moves. The secondary transfer roller 13 is disposed opposite one of the rollers that support the intermediate transfer belt 11. The secondary transfer roller 13 is pressed against the one of the rollers via the intermediate transfer belt 11, forming a secondary transfer nip between the secondary transfer roller 13 and the intermediate transfer belt 11.

The fixing portion 200 includes a fixing device 20 that fixes the toner image on the sheet P as one example of a sheet serving as the heated medium. The fixing device 20 includes a fixing belt 21 serving as a first rotator and a pressure roller 22 serving as a second rotator that contacts an outer circumferential face of the fixing belt 21 to form a nip N (e.g., a fixing nip) therebetween. The sheet supply portion 300 includes a sheet tray 14 and a feed roller 15. The sheet tray 14 loads a plurality of sheets P. The feed roller 15 picks up and feeds a sheet P from the sheet tray 14. The image forming apparatus 1000 further includes a timing roller pair 16 that is interposed between the feed roller 15 and the secondary transfer roller 13. The sheet output portion 400 includes an output roller pair 17 and an output tray 18. The output roller pair 17 ejects the sheet P onto the output tray 18. The output tray 18 is placed with the sheet P ejected by the output roller pair 17.

As the image forming apparatus 1000 having the construction described above starts a print job, the photoconductors 2 of the image forming units 1Y, 1M, 1C, and 1Bk rotate clockwise in FIG. 1 in directions indicated by arrows, respectively. The chargers 3 uniformly charge the surfaces of the photoconductors 2, respectively, at an increased electric potential. The exposure device 6 emits laser beams onto the charged surfaces of the photoconductors 2, respectively, according to image data of the print job sent from an external terminal, exposing the charged surfaces of the photoconductors 2. Alternatively, in a case that the image forming apparatus 1000 is a copier or an MFP, the exposure device 6 emits laser beams onto the charged surfaces of the photoconductors 2, respectively, according to image data created by an original scanner that reads an image on an original. Accordingly, the electric potential of an exposed portion on the surface of each of the photoconductors 2 decreases, forming a latent image (e.g., an electrostatic latent image) on the surface of each of the photoconductors 2. Thereafter, the developing devices 4 supply yellow, magenta, cyan, and black toners to the electrostatic latent images formed on the photoconductors 2, respectively, thus forming yellow, magenta, cyan, and back toner images on the photoconductors 2.

The yellow, magenta, cyan, and black toner images formed on the photoconductors 2 reach the primary transfer nips defined by the primary transfer rollers 12 in accordance with rotation of the photoconductors 2, respectively. The primary transfer rollers 12 transfer the yellow, magenta, cyan, and black toner images formed on the photoconductors 2 onto the intermediate transfer belt 11 at the primary transfer nips, respectively. As the primary transfer rollers 12 transfer the yellow, magenta, cyan, and black toner images formed on the photoconductors 2, respectively, onto the intermediate transfer belt 11 successively, that is driven and rotated in synchronism with rotation of the photoconductors 2, the yellow, magenta, cyan, and black toner images are superimposed on the intermediate transfer belt 11, forming a full color toner image on the intermediate transfer belt 11. The four image forming units 1Y, 1M, 1C, and 1Bk form the full color toner image. Alternatively, one of the four image forming units 1Y, 1M, 1C, and 1Bk may be used to form a monochrome toner image or two or three of the four image forming units 1Y, 1M, 1C, and 1Bk may be used to form a bicolor toner image or a tricolor toner image. After the toner image formed on the photoconductor 2 is transferred onto the intermediate transfer belt 11, the cleaner 5 cleans the surface of the photoconductor 2. Thus, the cleaner 5 removes a foreign substance such as residual toner from the surface of the photoconductor 2.

The full color toner image formed on the intermediate transfer belt 11 reaches the secondary transfer nip defined by the secondary transfer roller 13 in accordance with rotation of the intermediate transfer belt 11. The secondary transfer roller 13 transfers the full color toner image onto a sheet P at the secondary transfer nip. The sheet P is supplied from the sheet supply portion 300. For example, the feed roller 15 is driven and rotated to feed the sheet P from the sheet tray 14. The sheet P strikes the timing roller pair 16 before the sheet P reaches the secondary transfer nip. The timing roller pair 16 interrupts rotation and halts the sheet P temporarily. Thereafter, the timing roller pair 16 resumes rotation at a predetermined time, conveying the sheet P to the secondary transfer nip at a proper time when the full color toner image formed on the intermediate transfer belt 11 reaches the secondary transfer nip.

The sheet P transferred with the full color toner image is conveyed to the fixing portion 200. As the sheet P passes through the nip N formed between the fixing belt 21 and the pressure roller 22, the fixing belt 21 and the pressure roller 22 fix the full color toner image on the sheet P under heat and pressure. The sheet P is conveyed to the sheet output portion 400 where the output roller pair 17 ejects the sheet P onto an outside of the image forming apparatus 1000. The sheet P is placed on the output tray 18. Thus, a series of image forming processes finishes.

Referring to FIG. 2, a description is provided of a construction of the fixing device 20 according to an embodiment of the present disclosure.

FIG. 2 is a schematic cross-sectional view of the fixing device 20 according to the embodiment of the present disclosure.

The fixing device 20 includes the fixing belt 21, the pressure roller 22, the heater 23, a thermal conductor 24, a holder 25, a support 26, a separator 27, a thermistor 28 serving as a temperature detector, and a thermostat 29.

The fixing device 20 further includes a pressing assembly including a spring that causes the fixing belt 21 and the pressure roller 22 to press against each other. Thus, the fixing belt 21 and the pressure roller 22 form the nip N therebetween, through which the sheet P is conveyed. The fixing device 20 further includes a driver such as an electric motor that drives and rotates the pressure roller 22. As the driver drives and rotates the pressure roller 22 in a rotation direction indicated by arrow in FIG. 2, the fixing belt 21 rotates in a rotation direction indicated by arrow in FIG. 2 in accordance with rotation of the pressure roller 22. As a sheet P bearing an unfixed toner image 10 is conveyed through the nip N formed between the pressure roller 22 and the fixing belt 21 that rotate, the fixing belt 21 and the pressure roller 22 fix the unfixed toner image 10 on the sheet P under heat and pressure.

The fixing belt 21 is an endless belt that includes a base layer that is tubular and a release layer that is disposed on an outer circumferential face of the base layer. For example, the base layer of the fixing belt 21 is made of a metal material such as nickel and stainless steel or a resin material such as polyimide. For example, the release layer is made of perfluoroalkoxy alkane (PFA), polytetrafluoroethylene (PTFE), polyimide, polyether imide, polyether sulfone (PES), or the like. As the fixing belt 21 incorporates the release layer, the release layer facilitates separation of toner of the toner image formed on the sheet P from the fixing belt 21, preventing the sheet P from being wound around the fixing belt 21. The fixing belt 21 may further include an elastic layer that is interposed between the base layer and the release layer. For example, the elastic layer is made of a rubber material such as silicone rubber, silicone rubber foam, and fluororubber. In a case that the fixing belt 21 incorporates the elastic layer, the elastic layer prevents slight surface asperities from being produced on a surface of the fixing belt 21. Accordingly, heat is quickly conducted from the fixing belt 21 to the toner image on the sheet P evenly, improving fixing quality.

The pressure roller 22 includes a core metal that is hollow or solid, an elastic layer that is disposed on an outer circumferential face of the core metal, and a release layer that is disposed on an outer circumferential face of the elastic layer. The core metal is made of a metal material such as iron. The elastic layer is made of silicone rubber, silicone rubber foam, fluororubber, or the like. The release layer is made of fluororesin such as PFA and PTFE.

The heater 23, the thermal conductor 24, the holder 25, the support 26, the thermistor 28, and the thermostat 29 are disposed within a loop formed by the fixing belt 21. The heater 23 is disposed within the loop formed by the fixing belt 21 and disposed opposite the pressure roller 22. The heater 23 contacts an inner circumferential face of the fixing belt 21. Accordingly, the heater 23 and the pressure roller 22 sandwich the fixing belt 21, forming the nip N between the fixing belt 21 and the pressure roller 22. According to the embodiment, the heater 23 includes a base 50, a first resistive heating element 51, and an insulating layer 52. The base 50 is platy. The first resistive heating element 51 is planar and mounted on the base 50. The insulating layer 52 covers the first resistive heating element 51. As illustrated in FIG. 2, the first resistive heating element 51 is disposed opposite the inner circumferential face of the fixing belt 21 via the insulating layer 52. Accordingly, as the first resistive heating element 51 generates heat, the heat is conducted to the inner circumferential face of the fixing belt 21 through the insulating layer 52. Thus, the first resistive heating element 51 heats the inner circumferential face of the fixing belt 21.

In a state in which the heater 23 heats the fixing belt 21 to a predetermined temperature, as the sheet P bearing the unfixed toner image 10 enters the nip N, the fixing belt 21 and the pressure roller 22 fix the unfixed toner image 10 on the sheet P under heat and pressure. Alternatively, conversely to the construction of the fixing device 20 according to the embodiment, the heater 23 may be reversed such that the base 50 contacts the inner circumferential face of the fixing belt 21. In this case, heat generated by the first resistive heating element 51 is conducted to the fixing belt 21 through the base 50. Hence, the base 50 is preferably made of a material having an increased thermal conductivity.

The thermal conductor 24 contacts a back face of the heater 23, that is opposite to a front face of the heater 23, that contacts the fixing belt 21. The thermal conductor 24 conducts heat generated by the heater 23 to a portion of the heater 23, that has a relatively decreased temperature. Hence, the thermal conductor 24 is made of a material having a thermal conductivity that is greater than a thermal conductivity of the holder 25 and the like. For example, the thermal conductor 24 is made of copper, aluminum, graphene, or the like. The thermal conductor 24 is constructed of a single layer or a plurality of layers.

The holder 25 holds the heater 23 and the thermal conductor 24. According to the embodiment, the holder 25 includes a recess 25a that accommodates the heater 23 and the thermal conductor 24. Since the holder 25 is subject to a high temperature by heat from the heater 23, the holder 25 is preferably made of a heat-resistant material. In a case that the holder 25 is made of heat-resistant resin, such as liquid crystal polymer (LCP), that has a decreased thermal conductivity, the holder 25 suppresses redundant conduction of heat from the heater 23 to the holder 25, improving efficiency in heating of the fixing belt 21 by the heater 23.

The support 26 supports the holder 25. As illustrated in FIG. 2, the support 26 supports a back face of the holder 25, that is opposite to a front face of the holder 25, that is disposed opposite the pressure roller 22. Hence, the support 26 prevents the holder 25 from being bent by pressure from the pressure roller 22. Thus, the support 26 causes the heater 23 to form the nip N that has an even width in a sheet conveyance direction CD throughout an entire span of the fixing belt 21 in an axial direction thereof. The support 26 is preferably made of a ferrous metal material such as stainless used steel (SUS) and steel electrolytic cold commercial (SECC) to achieve rigidity.

The separator 27 is disposed downstream from the nip N in the sheet conveyance direction CD. The separator 27 separates the sheet P from the outer circumferential face of the fixing belt 21. As illustrated in FIG. 2, after a leading end of the sheet P passes through the nip N, the separator 27 enters a gap between the leading end of the sheet P and the fixing belt 21, separating the sheet P from the surface (e.g., the outer circumferential face) of the fixing belt 21. In order to improve separation of the sheet P, a tip of the separator 27 is preferably disposed in proximity to the outer circumferential face of the fixing belt 21 but does not contact the outer circumferential face of the fixing belt 21. The separator 27 may be secured to a frame of the fixing device 20 or may move closer to and separate from the fixing belt 21.

According to the embodiment, in order to improve separation of the sheet P, an edge of the recess 25a of the holder 25 protrudes beyond the heater 23 toward the pressure roller 22. Accordingly, at a position downstream from the nip N in the sheet conveyance direction CD, the fixing belt 21 bends substantially along the edge of the recess 25a of the holder 25, facilitating separation of the sheet P from the fixing belt 21. The edge of the recess 25a of the holder 25 protrudes beyond the heater 23 toward the pressure roller 22, preventing the fixing belt 21 from contacting an edge of the heater 23 and being damaged. Alternatively, in a case that the fixing belt 21 is immune from contact with the edge of the heater 23 and resultant damage or in a case that the fixing belt 21 ensures separation of the sheet P sufficiently, the heater 23 may protrude beyond the edge of the recess 25a of the holder 25 toward the pressure roller 22.

The thermistor 28 serving as the temperature detector is a temperature sensor for temperature control to retain a predetermined temperature of the heater 23. The thermostat 29 is a temperature sensor for overheat prevention to prevent the heater 23 from overheating. As the thermistor 28 is disposed opposite the heater 23 via the thermal conductor 24, the thermistor 28 detects a temperature of the heater 23 indirectly. Conversely, in order to improve responsiveness, the thermostat 29 penetrates through the thermal conductor 24 and contacts the heater 23 directly. Alternatively, under a specific condition, like the thermistor 28, the thermostat 29 may be disposed opposite the heater 23 indirectly via the thermal conductor 24. The fixing device 20 further includes a controller that receives the temperature of the heater 23, that is detected by the thermistor 28, as temperature data. The controller controls heat generation of the heater 23 according to the temperature data, retaining a predetermined target temperature of the heater 23. In a case that the thermostat 29 detects overheating of the heater 23, the controller interrupts power supply to the heater 23, shutting off heat generation of the heater 23 forcibly.

A description is provided of a construction of a comparative image forming apparatus.

The comparative image forming apparatus includes a fixing device that includes a fixing belt, a pressure roller, and a heater. The heater includes a resistive heating element. In a case that the fixing device fixes toner images continuously on small media, respectively, that have a small size smaller than a maximum size available in the comparative image forming apparatus, both lateral end portions of the resistive heating element in a longitudinal direction thereof protrude beyond the small media in a width direction thereof. Since the small media are not disposed opposite both lateral end portions of the resistive heating element in the longitudinal direction thereof and therefore do not draw heat from both lateral end portions of the resistive heating element, both lateral end portions of the resistive heating element may overheat. To address the circumstance, both lateral end portions of the resistive heating element in the longitudinal direction thereof have a thickness in a short direction that is perpendicular to the longitudinal direction of the resistive heating element, that is greater than a thickness in the short direction of a center portion of the resistive heating element in the longitudinal direction thereof. Accordingly, both lateral end portions of the resistive heating element in the longitudinal direction thereof have an increased electric resistance that decreases a heat generation amount of both lateral end portions of the resistive heating element in the longitudinal direction thereof.

However, as the thickness of both lateral end portions of the resistive heating element in the longitudinal direction thereof increases, the resistive heating element may protrude beyond a fixing nip formed between the fixing belt and the pressure roller in the short direction of the resistive heating element. A protruding portion of the resistive heating element, that protrudes beyond the fixing nip, does not press against a medium. Accordingly, the medium does not draw heat from the protruding portion of the resistive heating element. Consequently, the protruding portion of the resistive heating element may overheat. For example, the overheated resistive heating element may degrade grease applied between the heater and a slide face of the fixing belt, that slides over the heater, degrading sliding of the fixing belt.

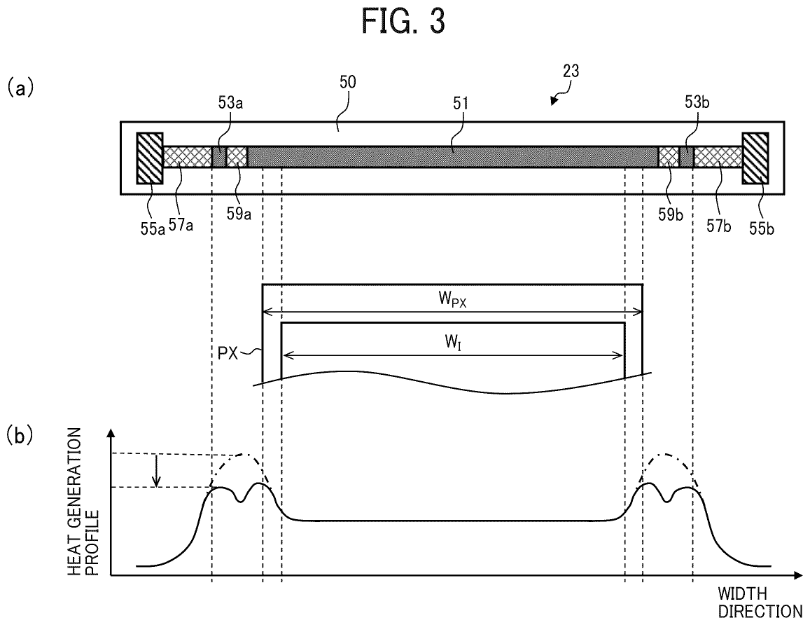

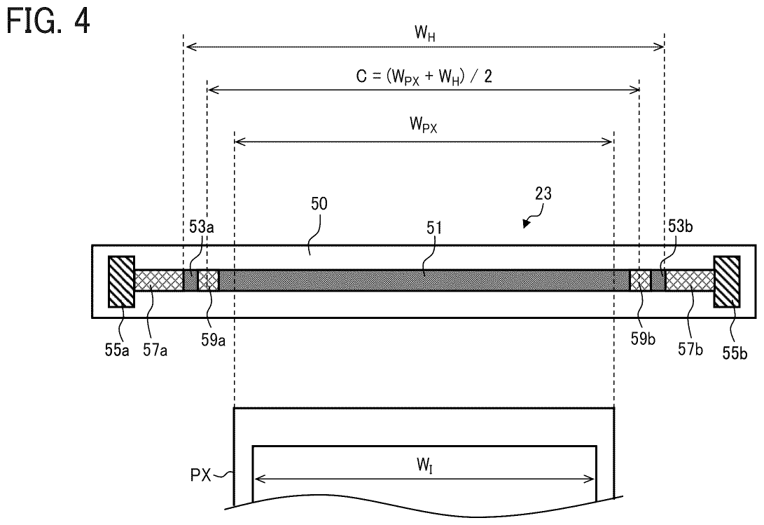

Referring to FIGS. 3 and 4, a description is provided of a construction of the heater 23 according to a first embodiment of the present disclosure.

FIGS. 3 and 4 illustrate a plan view of the heater 23 according to the first embodiment of the present disclosure.

The heater 23 includes the base 50 that is platy, the first resistive heating element 51, second resistive heating elements 53a and 53b, electrodes 55a and 55b, fourth conductors 57a and 57b, a first conductor 59a, and a second conductor 59b. At least the first resistive heating element 51, the second resistive heating elements 53a and 53b, and the electrodes 55a and 55b are mounted on an identical face of the base 50. Like the first resistive heating element 51, the second resistive heating elements 53a and 53b also generate heat used to fix a toner image on a sheet P.

For example, the base 50 is made of ceramics, such as alumina and aluminum nitride, or a nonmetallic material, such as glass and mica, having an enhanced heat resistance and an enhanced insulation. Alternatively, the heater 23 may further include an insulating layer that is interposed between the base 50 and the first resistive heating element 51. Hence, the base 50 may be made of a conductive material such as metal. The metal is preferably aluminum, stainless steel, or the like that is available at reduced costs. In order to suppress uneven temperature of the heater 23 and improve quality of the toner image formed on the sheet P, the base 50 may be made of a material that has an increased thermal conductivity such as copper, graphite, and graphene. Graphene is a substance produced with carbon atoms combined into a sheet shape.

The first resistive heating element 51 and the second resistive heating elements 53a and 53b are produced by screen printing or the like. For example, the first resistive heating element 51 is produced as below. Silver-palladium (AgPd), glass powder, and the like are mixed into paste. The paste coats the base 50 by screen printing. Thereafter, the base 50 is subject to firing. Alternatively, the first resistive heating element 51 may be made of a resistive material such as a silver alloy (AgPt) and ruthenium oxide (RuO₂) instead of silver-palladium.

Each of the electrodes 55a and 55b, the fourth conductors 57a and 57b, the first conductor 59a, and the second conductor 59b is made of a conductor that has a resistance value per unit length that is smaller than a resistance value per unit length of each of the first resistive heating element 51 and the second resistive heating elements 53a and 53b. For example, the electrodes 55a and 55b, the fourth conductors 57a and 57b, the first conductor 59a, and the second conductor 59b are produced with silver (Ag) or silver-palladium (AgPd) by screen printing or the like. Each of the first resistive heating element 51 and the second resistive heating elements 53a and 53b has an identical resistance value per unit length. However, a length of the first resistive heating element 51 is different from a length of each of the second resistive heating elements 53a and 53b in a longitudinal direction of the heater 23. Hence, a heat generation amount of the first resistive heating element 51 is greater than a heat generation amount of each of the second resistive heating elements 53a and 53b.

As illustrated in a section (a) of FIG. 3, the first resistive heating element 51 has a longitudinal direction (e.g., a horizontal direction in the section (a) of FIG. 3) and a short direction (e.g., a vertical direction in the section (a) of FIG. 3) that is perpendicular to the longitudinal direction. The first resistive heating element 51 extends in a longitudinal direction of the base 50. As illustrated in the section (a) of FIG. 3, the first resistive heating element 51 has a length in the longitudinal direction thereof, that is greater than a sheet width W_{PX} of a maximum sheet PX available in the heater 23. The maximum sheet PX is one example of a sheet serving as a heated medium. The sheet width W_{PX} is one example of a maximum width of the heated medium in a width direction thereof, that is, the longitudinal direction of the first resistive heating element 51. FIG. 3 illustrates a maximum image width W_{I} that indicates a width of a maximum image formed on the maximum sheet PX. The maximum image width W_{I} is one example of an imaging span in the width direction of the heated medium, that is, the longitudinal direction of the first resistive heating element 51. A lateral end of the first resistive heating element 51 is disposed outboard from the maximum image width W_{I} in the longitudinal direction of the first resistive heating element 51. The length of the first resistive heating element 51 in the longitudinal direction thereof is greater than the maximum image width W_{I} of the maximum sheet PX.

One of the second resistive heating elements 53a and 53b, that is, the second resistive heating element 53a, is disposed in proximity to one lateral end of the first resistive heating element 51 in the longitudinal direction thereof. Another one of the second resistive heating elements 53a and 53b, that is, the second resistive heating element 53b, is disposed in proximity to another lateral end of the first resistive heating element 51 in the longitudinal direction thereof. The second resistive heating elements 53a and 53b are spaced apart from one lateral end and another lateral end of the first resistive heating element 51, respectively, for a predetermined length in the longitudinal direction of the first resistive heating element 51. Each of the second resistive heating elements 53a and 53b has a length in the longitudinal direction of the heater 23, that is smaller than a length of the first resistive heating element 51 in the longitudinal direction thereof. As illustrated in the section (a) of FIG. 3, the second resistive heating elements 53a and 53b are disposed outboard from the sheet width W_{PX} of the maximum sheet PX in the longitudinal direction of the heater 23. Each of the second resistive heating elements 53a and 53b has a length in a short direction of the heater 23, that is equivalent to a length of the first resistive heating element 51 in the short direction of the heater 23.

One of the electrodes 55a and 55b, that is, the electrode 55a, is disposed farther from the first resistive heating element 51 than the second resistive heating element 53a is in the longitudinal direction of the heater 23. Another one of the electrodes 55a and 55b, that is, the electrode 55b, is disposed farther from the first resistive heating element 51 than the second resistive heating element 53b is in the longitudinal direction of the heater 23. Each of the electrodes 55a and 55b is spaced apart from an outboard lateral end of each of the second resistive heating elements 53a and 53b for a predetermined length in the longitudinal direction of the heater 23. In one lateral end span of the heater 23, that is disposed outboard from the first resistive heating element 51 in the longitudinal direction of the heater 23, the fourth conductor 57a connects the electrode 55a and the second resistive heating element 53a. The first conductor 59a connects the second resistive heating element 53a and the first resistive heating element 51.

In another lateral end span of the heater 23, that is disposed outboard from the first resistive heating element 51 in the longitudinal direction of the heater 23, the fourth conductor 57b connects the electrode 55b and the second resistive heating element 53b. The second conductor 59b connects the second resistive heating element 53b and the first resistive heating element 51. The second resistive heating elements 53a and 53b are disposed outboard from the first resistive heating element 51 in the longitudinal direction of the heater 23. The first resistive heating element 51 and the second resistive heating element 53a are electrically connected to the electrode 55a through the fourth conductor 57a and the first conductor 59a. The first resistive heating element 51 and the second resistive heating element 53b are electrically connected to the electrode 55b through the fourth conductor 57b and the second conductor 59b.

With the construction described above, each of the first conductor 59a and the second conductor 59b, that is disposed outboard from the sheet width W_{PX} of the maximum sheet PX in the longitudinal direction of the heater 23, defines a non-heat generation portion. Thus, the heater 23 suppresses temperature increase of each lateral end span of the heater 23 in the longitudinal direction thereof, that is, a non-conveyance span where the maximum sheet PX is not conveyed, without increasing the length of the first resistive heating element 51 in the short direction thereof. A section (b) of FIG. 3 is a diagram of a heat generation profile obtained with the first conductor 59a and the second conductor 59b and a heat generation profile obtained without the first conductor 59a and the second conductor 59b for comparison. The section (b) of FIG. 3 illustrates a solid waveform indicated by a solid line, that is obtained with the first conductor 59a and the second conductor 59b. The section (b) of FIG. 3 illustrates a broken waveform indicated by an alternate long and short dash line, that is obtained without the first conductor 59a and the second conductor 59b. A part of the broken waveform, that overlaps the solid waveform, is indicated by the solid line. As illustrated in the section (b) of FIG. 3 with the solid waveform, the first conductor 59a and the second conductor 59b suppress temperature increase of both lateral end spans of the heater 23, that are disposed outboard from the sheet width W_{PX} of the maximum sheet PX in the longitudinal direction of the heater 23 effectively.

Each of the first conductor 59a and the second conductor 59b defines the non-heat generation portion. As the first conductor 59a and the second conductor 59b are applied with an electric current, heat generates in a certain amount that is neglectable compared to an amount of heat generated by the first resistive heating element 51. With the construction of the heater 23 described above, each of the second resistive heating elements 53a and 53b, that has the length smaller than the length of the first resistive heating element 51 in the longitudinal direction of the heater 23, is disposed outboard from the first resistive heating element 51 in the longitudinal direction of the heater 23. Without the second resistive heating elements 53a and 53b, both lateral end spans of the heater 23, that are disposed outboard from the first resistive heating element 51 in the longitudinal direction thereof, may have a decreased temperature. Accordingly, the heater 23 may not attain a target fixing temperature. To address the circumstance, the second resistive heating elements 53a and 53b suppress temperature decrease of both lateral end spans of the heater 23, respectively, that are disposed outboard from the first resistive heating element 51 in the longitudinal direction thereof. Thus, the second resistive hearing elements 53a and 53b ensure the target fixing temperature in both lateral end spans of the heater 23 in the longitudinal direction thereof, respectively.

In the heater 23 according to the first embodiment, as illustrated in FIG. 4, the maximum sheet PX has the sheet width W_{PX}. The outboard lateral end of one second resistive heating element, that is, the second resistive heating element 53a, and the outboard lateral end of another second resistive heating element, that is, the second resistive heating element 53b, define a heat generation span W_{H} therebetween in the longitudinal direction of the heater 23. The first conductor 59a is spaced apart from the second conductor 59b in the longitudinal direction of the heater 23 with a clearance C therebetween, that is calculated by a formula of C=(W_{PX}+W_{H})/2. For example, as illustrated in FIG. 4, the first conductor 59a overlaps a start of a length of the clearance C calculated by the formula. The second conductor 59b overlaps an end of the length of the clearance C calculated by the formula. Thus, each of the first conductor 59a and the second conductor 59b is disposed in an increased temperature portion of the heater 23, that is subject to a peak temperature, suppressing temperature increase of both lateral end spans of the heater 23 in the longitudinal direction thereof. For example, the formula is obtained by determining a location of the peak temperature of the heater 23 in the longitudinal direction thereof based on experiment data and the like. The formula may be changed properly according to the construction of the fixing device 20, a property of the heated medium, and the like.

A description is provided of a construction of a heater 23A according to a second embodiment of the present disclosure.

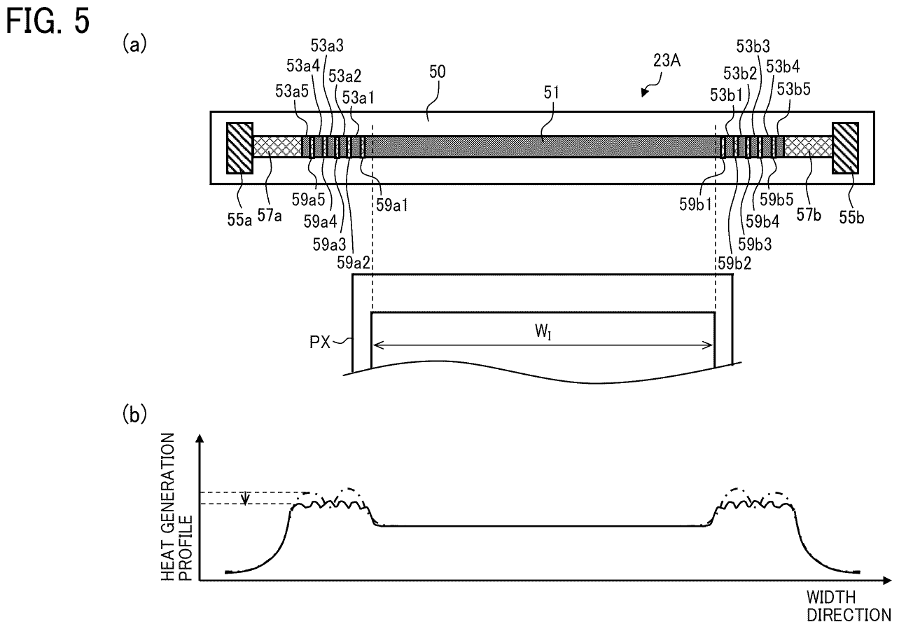

FIG. 5 is a plan view of the heater 23A according to the second embodiment of the present disclosure.

The heater 23A according to the second embodiment is different from the heater 23 according to the first embodiment in that the heater 23A includes a plurality of second resistive heating elements 53a1, 53a2, 53a3, 53a4, and 53a5 arranged in a longitudinal direction of the heater 23A and disposed in one lateral end span of the heater 23A in the longitudinal direction thereof, instead of the second resistive heating element 53a. In accordance with the plurality of second resistive heating elements 53a1, 53a2, 53a3, 53a4, and 53a5, the heater 23A further includes a plurality of first conductors 59a1, 59a2, 59a3, 59a4, and 59a5 arranged in the longitudinal direction of the heater 23A instead of the first conductor 59a. The second resistive heating elements 53a1, 53a2, 53a3, 53a4, and 53a5 are arranged with the first conductors 59a1, 59a2, 59a3, 59a4, and 59a5 alternately. Similarly, the heater 23A further includes a plurality of second resistive heating elements 53b1, 53b2, 53b3, 53b4, and 53b5 instead of the second resistive heating element 53b and a plurality of second conductors 59b1, 59b2, 59b3, 59b4, and 59b5 instead of the second conductor 59b. The second resistive heating elements 53b1, 53b2, 53b3, 53b4, and 53b5 and the second conductors 59b1, 59b2, 59b3, 59b4, and 59b5 are arranged in the longitudinal direction of the heater 23A alternately and disposed in another lateral end span of the heater 23A in the longitudinal direction thereof. The second resistive heating elements 53b1, 53b2, 53b3, 53b4, and 53b5 are arranged with the second conductors 59b1, 59b2, 59b3, 59b4, and 59b5 alternately.

FIG. 5 includes a section (b) illustrating a heat generation profile of the heater 23 according to the first embodiment and a heat generation profile of the heater 23A according to the second embodiment for comparison. The section (b) of FIG. 5 illustrates a solid waveform indicated by a solid line, that is obtained with the heater 23A according to the second embodiment. The section (b) of FIG. 5 illustrates a broken waveform indicated by an alternate long and short dash line, that is obtained with the heater 23 according to the first embodiment. A part of the broken waveform, that overlaps the solid waveform, is indicated by the solid line. As illustrated in the section (b) of FIG. 5, the heater 23A according to the second embodiment decreases temperature ripple of the second resistive heating elements 53a1, 53a2, 53a3, 53a4, 53a5, 53b1, 53b2, 53b3, 53b4, and 53b5, compared to the heater 23 according to the first embodiment, thus decreasing temperature increase in both lateral end spans of the heater 23A in the longitudinal direction thereof.

A description is provided of a construction of a heater 23B according to a third embodiment of the present disclosure.

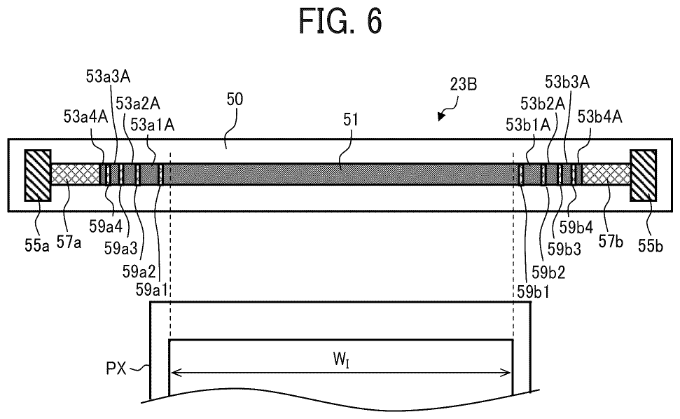

FIG. 6 is a plan view of the heater 23B according to the third embodiment of the present disclosure.

The heater 23B according to the third embodiment is different from the heater 23A according to the second embodiment in that the heater 23B includes a plurality of second resistive heating elements 53a1A, 53a2A, 53a3A, 53a4A, 53b1A, 53b2A, 53b3A, and 53b4A that are arranged in a longitudinal direction of the heater 23B with respect to the plurality of first conductors 59a1, 59a2, 59a3, and 59a4 and the plurality of second conductors 59b1, 59b2, 59b3, and 59b4, instead of the second resistive heating elements 53a1, 53a2, 53a3, 53a4, 53a5, 53b1, 53b2, 53b3, 53b4, and 53b5. For example, the second resistive heating elements 53a1A, 53a2A, 53a3A, and 53a4A are arranged with the first conductors 59a1, 59a2, 59a3, and 59a4 alternately in the longitudinal direction of the heater 23B with gaps between the adjacent first conductors 59a1, 59a2, 59a3, and 59a4, that decrease toward the electrode 55a. The second resistive heating elements 53a1A, 53a2A, 53a3A, and 53a4A have different lengths in the longitudinal direction of the heater 23B, respectively, that decrease toward the electrode 55a. The second resistive heating element 53a4A disposed in proximity to the electrode 55a has a smallest length in the longitudinal direction of the heater 23B. The first conductors 59a1, 59a2, 59a3, and 59a4 have an identical length in the longitudinal direction of the heater 23B. Similarly, the second resistive heating elements 53b1A, 53b2A, 53b3A, and 53b4A are arranged with the second conductors 59b1, 59b2, 59b3, and 59b4 alternately in the longitudinal direction of the heater 23B with gaps between the adjacent second conductors 59b1, 59b2, 59b3, and 59b4, that decrease toward the electrode 55b. The second resistive heating elements 53b1A, 53b2A, 53b3A, and 53b4A have different lengths in the longitudinal direction of the heater 23B, respectively, that decrease toward the electrode 55b. The second resistive heating element 53b4A disposed in proximity to the electrode 55b has a smallest length in the longitudinal direction of the heater 23B. The second conductors 59b1, 59b2, 59b3, and 59b4 have an identical length in the longitudinal direction of the heater 23B.

The heater 23B according to the third embodiment gradually decreases a heat generation amount outward from both outboard lateral ends of the first resistive heating element 51 in the longitudinal direction thereof to the electrodes 55a and 55b, respectively. Accordingly, the heater 23B also decreases thermal stress during heating, preventing breakage of the heater 23B even when the heater 23B malfunctions, for example.

A description is provided of a construction of a heater 23C according to a fourth embodiment of the present disclosure.

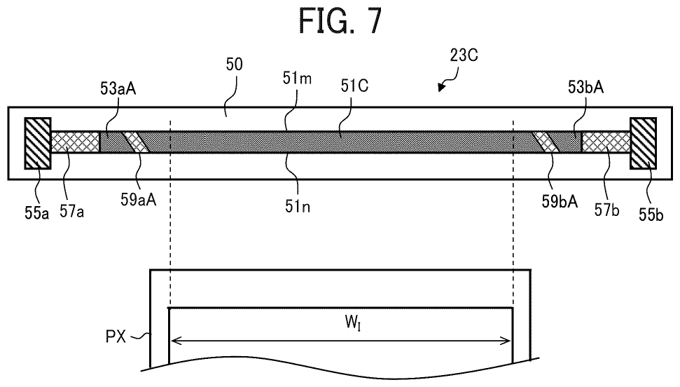

FIG. 7 is a plan view of the heater 23C according to the fourth embodiment of the present disclosure.

The heater 23C according to the fourth embodiment is different from the heater 23 according to the first embodiment in that the heater 23C includes a first conductor 59aA and a second conductor 59bA that are inclined with respect to a longitudinal direction of the heater 23C, instead of the first conductor 59a and the second conductor 59b. For example, the first conductor 59aA and the second conductor 59bA are inclined with respect to the longitudinal direction of the heater 23C in an identical inclination direction.

The heater 23C according to the fourth embodiment further includes a first resistive heating element 51C and second resistive heating elements 53aA and 53bA, instead of the first resistive heating element 51 and the second resistive heating elements 53a and 53b. The first resistive heating element 51C has a long side 51m that is extended in a longitudinal direction of the first resistive heating element 51C and disposed at one end of the first resistive heating element 51C in a short direction thereof and a long side 51n that is extended in the longitudinal direction of the first resistive heating element 51C and disposed at another end of the first resistive heating element 51C in the short direction thereof. The long sides 51m and 51n have an identical length in the longitudinal direction of the first resistive heating element 51C. Accordingly, the heater 23C suppresses temperature increase of both lateral end spans of the heater 23C in the longitudinal direction thereof. Additionally, the heater 23C attains a uniform heat flux density across a surface thereof, preventing breakage of the heater 23C due to thermal stress.

A description is provided of a construction of a heater 23D according to a fifth embodiment of the present disclosure.

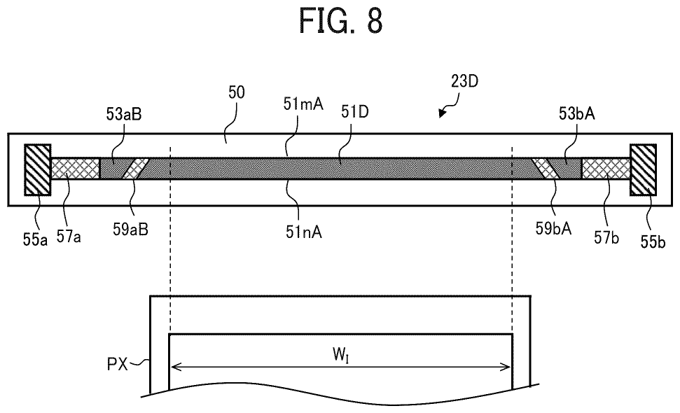

FIG. 8 is a plan view of the heater 23D according to the fifth embodiment of the present disclosure.

The heater 23D according to the fifth embodiment is different from the heater 23C according to the fourth embodiment in that the heater 23D includes a first conductor 59aB that is inclined with respect to a longitudinal direction of the heater 23D in an inclination direction that is different from an inclination direction in which the second conductor 59bA is inclined, instead of the first conductor 59aA.

The heater 23D according to the fifth embodiment further includes a first resistive heating element 51D and a second resistive heating element 53aB, instead of the first resistive heating element 51C and the second resistive heating element 53aA. The first resistive heating element 51D has a long side 51mA that is extended in a longitudinal direction of the first resistive heating element 51D and disposed at one end of the first resistive heating element 51D in a short direction thereof and a long side 51nA that is extended in the longitudinal direction of the first resistive heating element 51D and disposed at another end of the first resistive heating element 51D in the short direction thereof. The long sides 51mA and 51nA have different lengths, respectively, in the longitudinal direction of the first resistive heating element 51D. For example, the length of the long side 51nA is longer than the length of the long side 51mA in the longitudinal direction of the first resistive heating element 51D. When the heater 23D according to the fifth embodiment is installed into the fixing device 20, the long side 51nA that is longer than the long side 51mA is located at an upstream position in the rotation direction of the fixing belt 21, that is indicated by arrow in FIG. 2. The long side 51mA that is shorter than the long side 51nA is located at a downstream position in the rotation direction of the fixing belt 21. Accordingly, the heater 23D suppresses temperature increase of both lateral end spans of the heater 23D in the longitudinal direction thereof. Additionally, the first conductor 59aB and the second conductor 59bA return a lubricant such as grease interposed between the heater 23D and the inner circumferential face of the fixing belt 21 that slides over the heater 23D to a center span of the heater 23D in the longitudinal direction thereof, preventing leakage of the lubricant from the fixing belt 21 and extending a life of the fixing belt 21.

A description is provided of a construction of a heater 23E according to a sixth embodiment of the present disclosure.

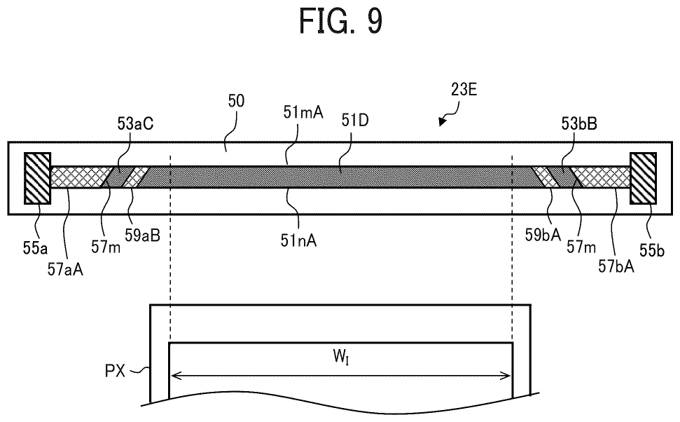

FIG. 9 is a plan view of the heater 23E according to the sixth embodiment of the present disclosure.

The heater 23E according to the sixth embodiment is different from the heater 23D according to the fifth embodiment in that the heater 23E includes fourth conductors 57aA and 57bA having inclined sides 57m, respectively, instead of the fourth conductors 57a and 57b. The heater 23E further includes second resistive heating elements 53aC and 53bB. For example, the inclined side 57m of the fourth conductor 57aA, that abuts on the second resistive heating element 53aC, is inclined in an inclination direction that is identical to an inclination direction in which the first conductor 59aB disposed in proximity to the fourth conductor 57aA is inclined. Similarly, the inclined side 57m of the fourth conductor 57bA, that abuts on the second resistive heating element 53bB, is inclined in an inclination direction that is identical to an inclination direction in which the second conductor 59bA disposed in proximity to the fourth conductor 57bA is inclined. Each of the second resistive heating elements 53aC and 53bB has inclined sides that define both lateral ends of each of the second resistive heating elements 53aC and 53bB in a longitudinal direction of the heater 23E, respectively, and are inclined in an identical inclination direction that is identical to the inclination direction of the inclined side 57m.

The heater 23E according to the sixth embodiment suppresses temperature increase of both lateral end spans of the heater 23E in the longitudinal direction thereof. Additionally, each of the second resistive heating elements 53aC and 53bB attains a uniform heat flux density across a surface of the heater 23E, preventing breakage of the heater 23E due to thermal stress.

A description is provided of a construction of a heater 23F according to a seventh embodiment of the present disclosure.

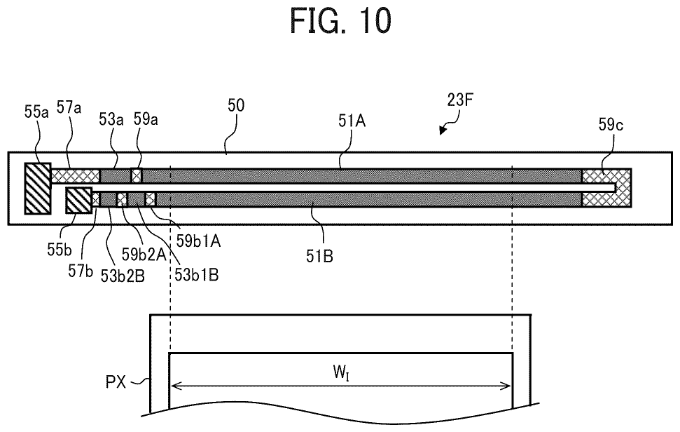

FIG. 10 is a plan view of the heater 23F according to the seventh embodiment of the present disclosure.

The heater 23F according to the seventh embodiment is different from the heater 23 according to the first embodiment in that the heater 23F includes a third conductor 59c and a plurality of first resistive heating elements 51A and 51B. The first resistive heating element 51A is arranged with the first resistive heating element 51B in a short direction of the heater 23F. A number of first resistive heating elements and the like that are adjacent to each other in the short direction of the heater 23F is not limited. As one example, FIG. 10 illustrates two first resistive heating elements, that is, the first resistive heating elements 51A and 51B, that are arranged in two rows. For example, like in the heater 23 according to the first embodiment, the electrode 55a, the fourth conductor 57a, the second resistive heating element 53a, and the first conductor 59a are disposed outboard from one lateral end of the first resistive heating element 51A in a longitudinal direction thereof as one of the first resistive heating elements 51A and 51B arranged in two rows. Another lateral end of the first resistive heating element 51A in the longitudinal direction thereof is connected to one inboard end of the third conductor 59c in a longitudinal direction of the heater 23F.

The heater 23F further includes second resistive heating elements 53b1B and 53b2B and second conductors 59b1A and 59b2A. The electrode 55b, the fourth conductor 57b, the second resistive heating elements 53b1B and 53b2B, and the second conductors 59b1A and 59b2A are disposed outboard from one lateral end of the first resistive heating element 51B in a longitudinal direction thereof as another one of the first resistive heating elements 51A and 51B arranged in two rows. FIG. 10 illustrates the plurality of second resistive heating elements 53b1B and 53b2B and the plurality of second conductors 59b1A and 59b2A as one example. Accordingly, the heater 23F decreases temperature ripple. Another lateral end of the first resistive heating element 51B in the longitudinal direction thereof is connected to another inboard end of the third conductor 59c in the longitudinal direction of the heater 23F. The third conductor 59c and the first resistive heating elements 51A and 51B form a U-shape.

The electrodes 55a and 55b are disposed in an identical lateral end span of the heater 23F in the longitudinal direction thereof. The first conductor 59a is electrically connected to the first resistive heating element 51A as one of the first resistive heating elements 51A and 51B arranged in two rows. The second conductors 59b1A and 59b2A are electrically connected to the first resistive heating element 51B as another one of the first resistive heating elements 51A and 51B arranged in two rows. The first conductor 59a and the second conductors 59b1A and 59b2A are shifted from each other in the longitudinal direction of the heater 23F.

The heater 23F according to the seventh embodiment suppresses temperature increase of both lateral end spans of the heater 23F in the longitudinal direction thereof. Additionally, the single first conductor 59a and the two second conductors 59b1A and 59b2A are shifted from each other in the longitudinal direction of the heater 23F. Hence, compared to a configuration in which the first conductor 59a and the second conductors 59b1A and 59b2A are disposed opposite each other, the first conductor 59a and the second conductors 59b1A and 59b2A are spaced apart from each other with an increased distance therebetween, preventing dielectric breakdown of the heater 23F. Each of the first resistive heating elements 51A and 51B has a first length from one lateral end (e.g., a right end in FIG. 10) of the maximum image width W_{I} to the third conductor 59c in the longitudinal direction of the heater 23F. The first resistive heating element 51A has a second length from another lateral end (e.g., a left end in FIG. 10) of the maximum image width W_{I} to the first conductor 59a in the longitudinal direction of the heater 23F. The first resistive heating element 51B has a third length from another lateral end (e.g., the left end in FIG. 10) of the maximum image width W_{I} to the second conductor 59b1A and a fourth length from another lateral end (e.g., the left end in FIG. 10) of the maximum image width W_{I} to the second conductor 59b2A in the longitudinal direction of the heater 23F. The first length is longer than each of the second length, the third length, and the fourth length. Thus, the heater 23F prevents temperature decrease in a lateral end portion of each of the first resistive heating elements 51A and 51B, that is disposed in proximity to the third conductor 59c in the longitudinal direction of the heater 23F, from decreasing a fixing temperature of a portion of the heater 23F, that is disposed in proximity to the maximum image width W_{I}, from a predetermined temperature.

A description is provided of a construction of a heater 23G according to an eighth embodiment of the present disclosure.

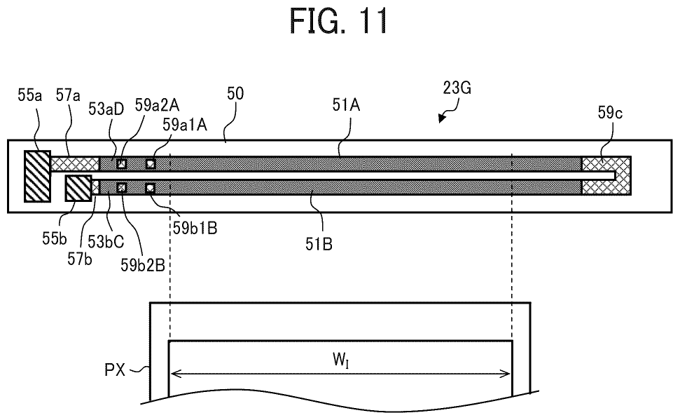

FIG. 11 is a plan view of the heater 23G according to the eighth embodiment of the present disclosure.

The heater 23G according to the eight embodiment is different from the heater 23F according to the seventh embodiment in that the heater 23G includes first conductors 59a1A and 59a2A, second conductors 59b1B and 59b2B, and second resistive heating elements 53aD and 53bC. The first conductors 59a1A and 59a2A and the second conductors 59b1B and 59b2B are smaller than the second resistive heating elements 53aD and 53bC, respectively, in a short direction of the heater 23G. For example, the first conductors 59a1A and 59a2A and the second conductors 59b1B and 59b2B are surrounded by the second resistive heating elements 53aD and 53bC, respectively.

The heater 23G according to the eighth embodiment suppresses temperature increase of both lateral end spans of the heater 23G in a longitudinal direction thereof. Additionally, the first conductors 59a1A and 59a2A and the second conductors 59b1B and 59b2B are spaced apart from each other with a sufficient distance therebetween, preventing dielectric breakdown of the heater 23G.

A description is provided of a construction of a heater 23H according to a ninth embodiment of the present disclosure.

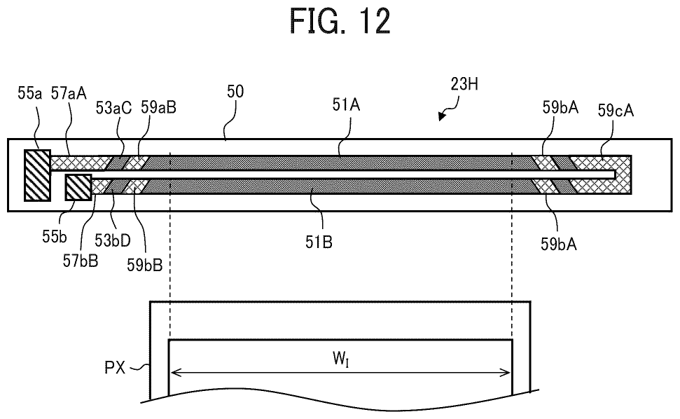

FIG. 12 is a plan view of the heater 23H according to the ninth embodiment of the present disclosure.

The heater 23H according to the ninth embodiment has the construction obtained by combining the construction of the heater 23E according to the sixth embodiment and the construction of the heater 23F according to the seventh embodiment. For example, the heater 23H includes a third conductor 59cA, a first conductor 59bB, a second resistive heating element 53bD, and a fourth conductor 57bB that are connected to the first resistive heating element 51B. The heater 23H according to the ninth embodiment suppresses temperature increase of both lateral end spans of the heater 23H in a longitudinal direction thereof. Additionally, each of the second resistive heating elements 53aC and 53bD attains a uniform heat flux density across a surface of the heater 23H, preventing breakage of the heater 23H due to thermal stress.

A description is provided of modification examples of the embodiments of the present disclosure.

The following describes a relation between a heater (e.g., the heater 23H) and the temperature detector, a relation between the heater and the thermal conductor 24, and the like as the heater is installed in the fixing device 20. Alternatively, the heater 23, 23A, 23B, 23C, 23D, 23E, 23F, or 23G may be installed in the fixing device 20.

A description is provided of installation examples of the temperature detector.

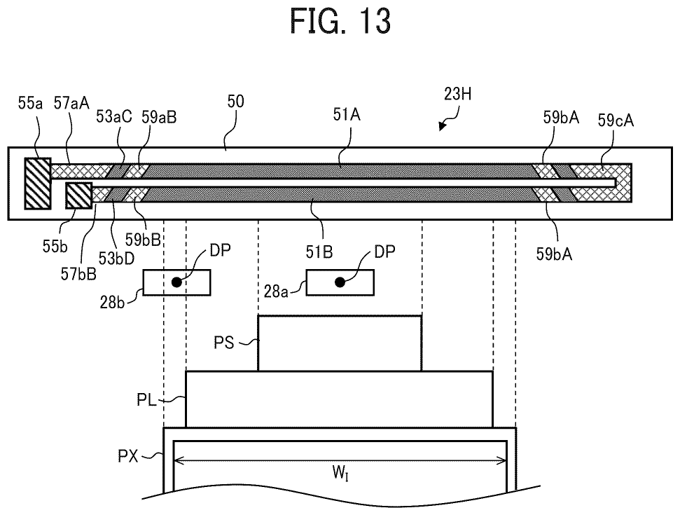

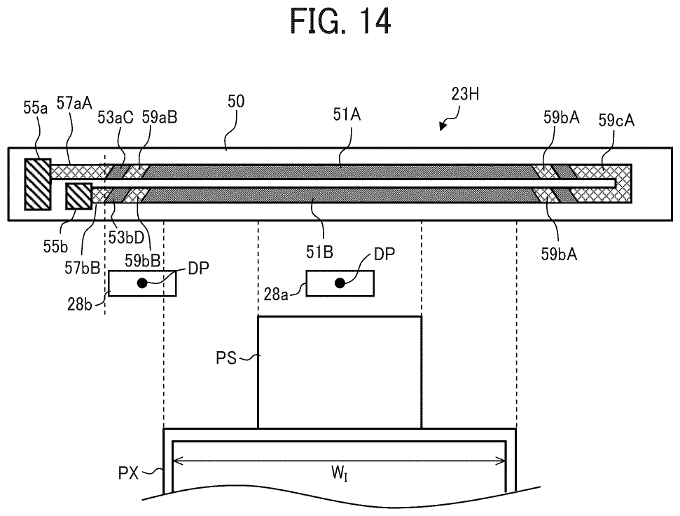

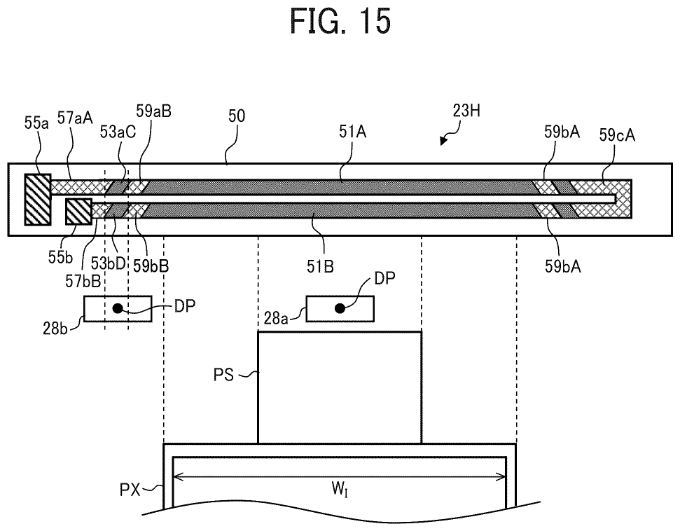

FIGS. 13, 14, and 15 illustrate the installation examples of the temperature detector. FIGS. 13, 14, and 15 illustrate thermistors 28a and 28b serving as the temperature detectors. FIG. 13 is a schematic diagram of the heater 23H and the thermistors 28a and 28b as a first installation example of the temperature detectors. FIG. 14 is a schematic diagram of the heater 23H and the thermistors 28a and 28b as a second installation example of the temperature detectors. FIG. 15 is a schematic diagram of the heater 23H and the thermistors 28a and 28b as a third installation example of the temperature detectors. FIGS. 13, 14, and 15 illustrate the heater 23H according to the ninth embodiment as one example.

FIG. 13 illustrates the first installation example of the two thermistors 28a and 28b. The thermistor 28a has a temperature detection point DP that is situated within a width of a minimum sheet PS in the longitudinal direction of the heater 23H. The thermistor 28b has a temperature detection point DP that is situated within a width of the maximum sheet PX and is situated outboard from a medium sheet PL in the longitudinal direction of the heater 23H. The medium sheet PL is smaller than the maximum sheet PX and is greater than the minimum sheet PS.

With the first installation example, the thermistors 28a and 28b detect a decreased temperature in one lateral end span of the heater 23H, that is lower than an increased temperature in a center span of the heater 23H in the longitudinal direction thereof, that might be caused by the first conductors 59aB and 59bB, the second conductors 59bA, and the like, for example. Thus, the thermistors 28a and 28b suppress faulty fixing.

FIG. 14 illustrates, as the second installation example, the thermistor 28b having a temperature detection point DP that is situated outboard from the maximum sheet PX and is situated inboard from the fourth conductor 57bB in the longitudinal direction of the heater 23H.

FIG. 15 illustrates, as the third installation example, the thermistor 28b having a temperature detection point DP that is disposed opposite the second resistive heating element 53bD.

According to the second installation example and the third installation example, the thermistor 28b detects a temperature of the heater 23H at a position outboard from the maximum sheet PX in the longitudinal direction of the heater 23H. The thermistor 28b prevents failures caused by erroneous setting of a thickness of a sheet P. For example, a user may erroneously place thick paper as sheets P in the sheet tray 14 while the user sets plain paper on a control panel of the image forming apparatus 1000 or on a printer driver. In this case, the heater 23H may suffer from overheating in both outboard spans disposed outboard from the sheet P in the longitudinal direction of the heater 23H.

A description is provided of installation examples of thermal conductors 24, 24A, and 24B installed in the fixing device 20.

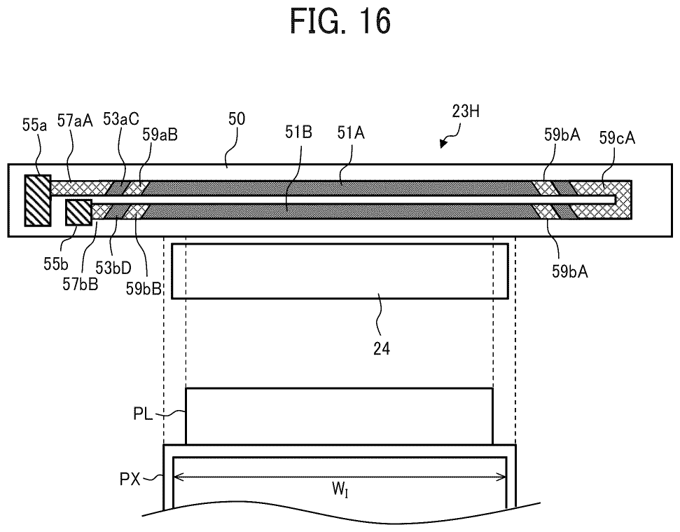

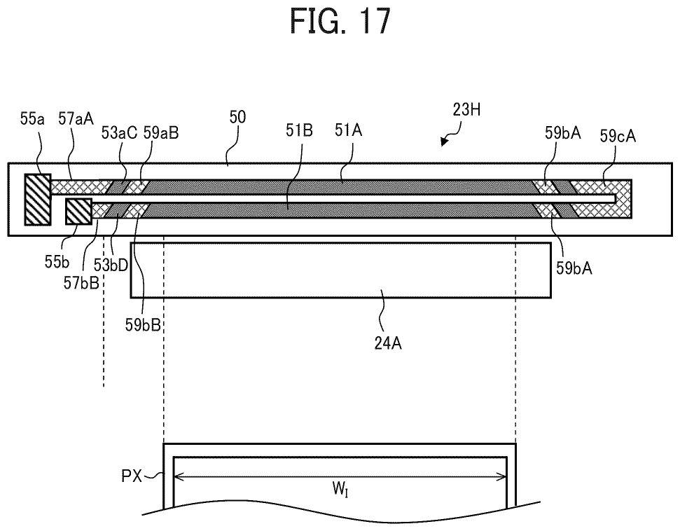

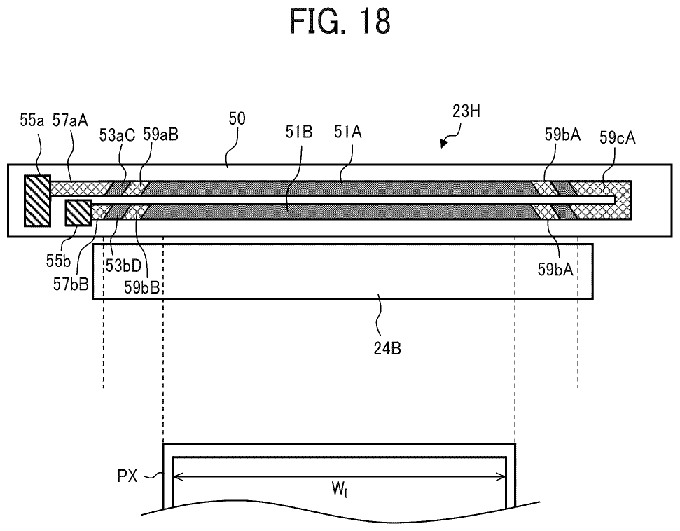

FIGS. 16, 17, and 18 illustrate the installation examples of the thermal conductors 24, 24A, and 24B. FIG. 16 is a schematic diagram of the heater 23H and the thermal conductor 24 as a first installation example of the thermal conductor 24. FIG. 17 is a schematic diagram of the heater 23H and the thermal conductor 24A as a second installation example of the thermal conductor 24A. FIG. 18 is a schematic diagram of the heater 23H and the thermal conductor 24B as a third installation example of the thermal conductor 24B. FIGS. 16, 17, and 18 illustrate the heater 23H according to the ninth embodiment as one example. Each of the thermal conductors 24, 24A, and 24B is made of a material having a thermal conductivity that is greater than a thermal conductivity of the base 50. As illustrated in FIG. 2, as the thermal conductor 24, 24A, or 24B is installed in the fixing device 20, the thermal conductor 24, 24A, or 24B contacts the heater 23.

As illustrated in FIG. 16, the thermal conductor 24 according to the first installation example is disposed opposite the heater 23H such that the thermal conductor 24 has a length that is shorter than the width of the maximum sheet PX and is longer than a width of the medium sheet PL in the longitudinal direction of the heater 23H. The medium sheet PL is smaller than the maximum sheet PX.

When the heater 23H heats a sheet P smaller than the maximum sheet PX, the thermal conductor 24 according to the first installation example serves as a thermal equalization plate that conducts heat, suppressing overheating of the heater 23H.

As illustrated in FIG. 17, the thermal conductor 24A according to the second installation example has a length that is longer than the width of the maximum sheet PX in the longitudinal direction of the heater 23H and is shorter than a clearance between the fourth conductor 57aA and the third conductor 59cA and a clearance between the fourth conductor 57bB and the third conductor 59cA in the longitudinal direction of the heater 23H.

As illustrated in FIG. 18, the thermal conductor 24B according to the third installation example has a length that extends in the longitudinal direction of the heater 23H from a position disposed opposite the fourth conductors 57aA and 57bB to a position disposed opposite the third conductor 59cA.

When the heater 23H heats the maximum sheet PX, the thermal conductor 24A according to the second installation example and the thermal conductor 24B according to the third installation example serve as thermal equalization plates, respectively, that conduct heat, suppressing overheating of the heater 23H.

The embodiments of the present disclosure described above provide at least aspects below.

A description is provided of a first aspect of the technology of the present disclosure.

As illustrated in FIG. 3, a heater (e.g., the heater 23) includes a first resistive heating element (e.g., the first resistive heating element 51 serving as a center resistive heating element), a first conductor (e.g., the first conductor 59a), a second conductor (e.g., the second conductor 59b), a first electrode (e.g., the electrode 55a), and a second electrode (e.g., the electrode 55b).

The first resistive heating element has a longitudinal direction and a short direction perpendicular to the longitudinal direction. The first conductor is connected to one lateral end of the first resistive heating element in the longitudinal direction thereof. The second conductor is connected to another lateral end of the first resistive heating element in the longitudinal direction thereof. The first electrode is disposed opposite the first resistive heating element via the first conductor in the longitudinal direction of the first resistive heating element. The first electrode is connected to the first conductor. The second electrode is disposed opposite the first resistive heating element via the second conductor in the longitudinal direction of the first resistive heating element. The second electrode is connected to the second conductor.

A description is provided of a second aspect of the technology of the present disclosure.

In the heater according to the first aspect, as illustrated in FIG. 3, the one lateral end and the another lateral end of the first resistive heating element are disposed outboard from an imaging span (e.g., the maximum image width W_{I}) of a heated medium (e.g., the maximum sheet PX) in the longitudinal direction of the first resistive heating element. The heated medium is heated by the heater.

A description is provided of a third aspect of the technology of the present disclosure.

As illustrated in FIG. 3, the heater according to the first aspect or the second aspect further includes second resistive heating elements (e.g., the second resistive heating element 53a serving as a first lateral end resistive heating element and the second resistive heating element 53b serving as a second lateral end resistive heating element) that are disposed outboard from the one lateral end and the another lateral end of the first resistive heating element in the longitudinal direction thereof, respectively. One of the second resistive heating elements is connected to the first resistive heating element via the first conductor. Another one of the second resistive heating elements is connected to the first resistive heating element via the second conductor.

A description is provided of a fourth aspect of the technology of the present disclosure.

In the heater according to the third aspect, the first resistive heating element has a length in the longitudinal direction thereof, that is greater than a sheet width W_{PX} of the heated medium having a maximum size available in the heater. As illustrated in FIG. 4, a heat generation span W_{H} extends from an outboard lateral end of the one of the second resistive heating elements to an outboard lateral end of the another one of the second resistive heating elements in the longitudinal direction of the first resistive heating element. A clearance C is interposed between the first conductor and the second conductor in the longitudinal direction of the first resistive heating element. The clearance C is calculated by a formula of C=(W_{PX}+W_{H})/2.

A description is provided of a fifth aspect of the technology of the present disclosure.

In the heater according to the third aspect or the fourth aspect, as illustrated in FIG. 5, the second resistive heating elements (e.g., the second resistive heating elements 53a1, 52a2, 53a3, 53a4, 53a5, 53b1, 53b2, 53b3, 53b4, and 53b5) are arranged in the longitudinal direction of the first resistive heating element. The first conductors (e.g., the first conductors 59a1, 59a2, 59a3, 59a4, and 59a5) and the second conductors (e.g., the second conductors 59b1, 59b2, 59b3, 59b4, and 59b5) are arranged in the longitudinal direction of the first resistive heating element.

A description is provided of a sixth aspect of the technology of the present disclosure.

In the heater according to the fifth aspect, as illustrated in FIG. 6, the second resistive heating elements (e.g., the second resistive heating elements 53a1A, 53a2A, 53a3A, 53a4A, 53b1A, 53b2A, 53b3A, and 53b4A) have lengths in the longitudinal direction of the first resistive heating element, that decrease toward the first electrode and the second electrode.

A description is provided of a seventh aspect of the technology of the present disclosure.

In the heater according to the first aspect or the third aspect, as illustrated in FIG. 7, the first conductor (e.g., the first conductor 59aA) and the second conductor (e.g., the second conductor 59bA) are inclined with respect to the longitudinal direction of the first resistive heating element.

A description is provided of an eighth aspect of the technology of the present disclosure.

In the heater according to the seventh aspect, as illustrated in FIG. 8, the first resistive heating element (e.g., the first resistive heating element 51D serving as a center resistive heating element) has a first side (e.g., the long side 51mA) that is extended in the longitudinal direction of the first resistive heating element and disposed at one end of the first resistive heating element in the short direction thereof and a second side (e.g., the long side 51nA) that is extended in the longitudinal direction of the first resistive heating element and disposed at another end of the first resistive heating element in the short direction thereof. The first side has a first length that is different from a second length of the second side in the longitudinal direction of the first resistive heating element.

A description is provided of a ninth aspect of the technology of the present disclosure.

As illustrated in FIG. 9, the heater according to the seventh aspect further includes a fourth conductor (e.g., the fourth conductor 57aA or 57bA) that has an inclined side (e.g., the inclined side 57m) abutting on the second resistive heating element. At least the inclined side of the fourth conductor is inclined in an inclination direction that is identical to an inclination direction in which the first conductor (e.g., the first conductor 59aB) or the second conductor (e.g., the second conductor 59bA) disposed in proximity to the fourth conductor is inclined.

A description is provided of a tenth aspect of the technology of the present disclosure.

As illustrated in FIG. 10, a heater (e.g., the heater 23F) includes a plurality of first resistive heating elements (e.g., the first resistive heating element 51A serving as a first center resistive heating element and the first resistive heating element 51B serving as a second center resistive heating element) that is arranged in a short direction of the first resistive heating elements. The heater further includes a third conductor (e.g., the third conductor 59c) that connects the first resistive heating elements.

A description is provided of an eleventh aspect of the technology of the present disclosure.

As illustrated in FIG. 10, the heater according to the tenth aspect further includes electrodes (e.g., the electrode 55a serving as the first electrode and the electrode 55b serving as the second electrode) that are disposed in one lateral end span of the heater in the longitudinal direction of the first resistive heating element.

A description is provided of a twelfth aspect of the technology of the present disclosure.

As illustrated in FIG. 10, the heater according to the tenth aspect includes the first conductor (e.g., the first conductor 59a) that is electrically connected to one of the first resistive heating elements (e.g., the first resistive heating element 51A serving as the first center resistive heating element) arranged in the short direction of the first resistive heating elements and the second conductor (e.g., the second conductors 59b1A and 59b2A) that is electrically connected to another one of the first resistive heating elements (e.g., the first resistive heating element 51B serving as the second center resistive heating element). The first conductor is shifted from the second conductor in the longitudinal direction of the first resistive heating elements.

A description is provided of a thirteenth aspect of the technology of the present disclosure.

As illustrated in FIG. 2, a fixing device (e.g., the fixing device 20) includes the heater according to any one of the first aspect to the twelfth aspect.

A description is provided of a fourteenth aspect of the technology of the present disclosure.

As illustrated in FIG. 1, an image forming apparatus (e.g., the image forming apparatus 1000) includes the fixing device according to the thirteenth aspect.

Accordingly, the heater suppresses temperature increase of both lateral end spans of the heater in the longitudinal direction of the first resistive heating element effectively.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heater for heating a heated medium, the heater comprising:
a center resistive heating element;
a first conductor connected to one lateral end of the center resistive heating element in a longitudinal direction of the center resistive heating element;
a second conductor connected to another lateral end of the center resistive heating element in the longitudinal direction of the center resistive heating element;
a first electrode disposed opposite the center resistive heating element via the first conductor in the longitudinal direction of the center resistive heating element, the first electrode connected to the first conductor; and
a second electrode disposed opposite the center resistive heating element via the second conductor in the longitudinal direction of the center resistive heating element, the second electrode connected to the second conductor.

2. The heater according to claim 1,
wherein the one lateral end and said another lateral end of the center resistive heating element are disposed outboard from an imaging span of the heated medium in the longitudinal direction of the center resistive heating element.

3. The heater according to claim 1, further comprising:
a first lateral end resistive heating element disposed outboard from the one lateral end of the center resistive heating element in the longitudinal direction of the center resistive heating element and connected to the center resistive heating element via the first conductor; and
a second lateral end resistive heating element disposed outboard from said another lateral end of the center resistive heating element in the longitudinal direction of the center resistive heating element and connected to the center resistive heating element via the second conductor.

4. The heater according to claim 3,
wherein the center resistive heating element has a length in the longitudinal direction of the center resistive heating element, the length being greater than a sheet width W_{PX} of the heated medium having a maximum size available in the heater,
wherein the first lateral end resistive heating element and the second lateral end resistive heating element define a heat generation span W_{H} that extends from an outboard lateral end of the first lateral end resistive heating element to an outboard lateral end of the second lateral end resistive heating element in the longitudinal direction of the center resistive heating element, and
wherein the first conductor and the second conductor define a clearance C that is interposed between the first conductor and the second conductor in the longitudinal direction of the center resistive heating element, the clearance C being calculated by a formula of C=(W_{PX}+W_{H})/2.

5. The heater according to claim 3, further comprising:
a third lateral end resistive heating element arranged with the first lateral end resistive heating element in the longitudinal direction of the center resistive heating element;
a fourth lateral end resistive heating element arranged with the second lateral end resistive heating element in the longitudinal direction of the center resistive heating element;
another first conductor arranged with the first conductor in the longitudinal direction of the center resistive heating element; and
another second conductor arranged with the second conductor in the longitudinal direction of the center resistive heating element.

6. The heater according to claim 5,
wherein the third lateral end resistive heating element is disposed closer to the first electrode than the first lateral end resistive heating element is in the longitudinal direction of the center resistive heating element and has a length that is smaller than a length of the first lateral end resistive heating element in the longitudinal direction of the center resistive heating element, and
wherein the fourth lateral end resistive heating element is disposed closer to the second electrode than the second lateral end resistive heating element is in the longitudinal direction of the center resistive heating element and has a length that is smaller than a length of the second lateral end resistive heating element in the longitudinal direction of the center resistive heating element.

7. The heater according to claim 1,
wherein the first conductor and the second conductor are inclined with respect to the longitudinal direction of the center resistive heating element.

8. The heater according to claim 7,
wherein the center resistive heating element has:
a first side extended in the longitudinal direction of the center resistive heating element and disposed at one end of the center resistive heating element in a short direction of the center resistive heating element; and
a second side extended in the longitudinal direction of the center resistive heating element and disposed at another end of the center resistive heating element in the short direction of the center resistive heating element, and
wherein the first side has a length that is different from a length of the second side in the longitudinal direction of the center resistive heating element.

9. The heater according to claim 7, further comprising a third conductor having an inclined side abutting on a first lateral end resistive heating element, the inclined side being inclined in an inclination direction that is identical to an inclination direction in which the first conductor that is disposed in proximity to the third conductor is inclined.

10. The heater according to claim 7, further comprising a third conductor having an inclined side abutting on a second lateral end resistive heating element, the inclined side being inclined in an inclination direction that is identical to an inclination direction in which the second conductor that is disposed in proximity to the third conductor is inclined.

11. A heater comprising:
a first center resistive heating element;
a second center resistive heating element arranged with the first center resistive heating element in a short direction of the first center resistive heating element;
a first conductor connected to the first center resistive heating element;
a second conductor connected to the second center resistive heating element;
a third conductor connecting the first center resistive heating element with the second center resistive heating element;
a first electrode disposed opposite the first center resistive heating element via the first conductor in a longitudinal direction of the first center resistive heating element, the first electrode connected to the first conductor; and
a second electrode disposed opposite the second center resistive heating element via the second conductor in a longitudinal direction of the second center resistive heating element, the second electrode connected to the second conductor.

12. The heater according to claim 11,
wherein the first electrode and the second electrode are disposed in one lateral end span of the heater in the longitudinal direction of the first center resistive heating element and the second center resistive heating element.

13. The heater according to claim 11,
wherein the first conductor is shifted from the second conductor in the longitudinal direction of the first center resistive heating element.

14. The heater according to claim 11,
wherein the first conductor is smaller than the first center resistive heating element in the short direction of the first center resistive heating element, and
wherein the second conductor is smaller than the second center resistive heating element in a short direction of the second center resistive heating element.

15. A fixing device comprising:
an endless belt to rotate; and
a heater to heat the endless belt,
the heater including:
a center resistive heating element;
a first conductor connected to one lateral end of the center resistive heating element in a longitudinal direction of the center resistive heating element;
a second conductor connected to another lateral end of the center resistive heating element in the longitudinal direction of the center resistive heating element;
a first electrode disposed opposite the center resistive heating element via the first conductor in the longitudinal direction of the center resistive heating element, the first electrode connected to the first conductor; and
a second electrode disposed opposite the center resistive heating element via the second conductor in the longitudinal direction of the center resistive heating element, the second electrode connected to the second conductor.

16. An image forming apparatus comprising the fixing device according to claim 15.
